(19) United States
(12) Patent Application Publication
(10) Pub. No.: US 2013/0297858 A1
(43) Pub. Date: Nov. 7, 2013

(54) SYSTEMS AND METHODS FOR PROVIDING CHANNEL BUFFER IN A SOLID-STATE DEVICE

(71) Applicant: STEC, INC., Santa Ana, CA (US)

(72) Inventor: Neal J. SCHNEIER, Laguna Niguel, CA (US)

(21) Appl. No.: 13/866,325

(22) Filed: Apr. 19, 2013

Related U.S. Application Data
(60) Provisional application No. 61/635,488, filed on Apr. 19, 2012.

(51) Int. Cl. G06F 12/02

(52) U.S. Cl. CPC G06F 12/0246
USPC 711/103

(57) ABSTRACT

Systems and methods for providing a buffer between a memory controller and memory devices in high performance solid state devices. Some embodiments include a solid state device system. The solid state device system can include a memory controller electrically coupled to a channel, where the memory controller is configured to select one of a plurality of flash memory devices and, in response to the selection, provide a control signal. The solid state device system can also include a buffer having a first tri-state logic gate coupled to the channel, where the buffer is configured to receive the control signal from the memory controller and, in response, to couple the channel to the selected one of the plurality of flash memory devices via the first tri-state logic gate and to decouple the remainder of the plurality of flash memory devices from the channel.

### CROSS-REFERENCE TO RELATED APPLICATION

This application claims the benefit of the earlier priority date of U.S. Provisional Patent Application No. 61/635,488, entitled “FLASH CHANNEL FLASH BUFFER,” filed on Apr. 19, 2012, which is hereby expressly incorporated herein by reference in its entirety. This application is related to U.S. patent application Ser. No. 13/475,668, entitled “SYSTEMS AND METHODS FOR PROVIDING LOAD ISOLATION IN A SOLID-STATE DEVICE,” filed on Feb. 8, 2013; U.S. Pat. No. 8,402,206, entitled “SOLID-STATE DEVICE WITH LOAD ISOLATION,” issued on Mar. 19, 2013; and U.S. Pat. No. 8,271,723, entitled “ISOLATION DEVICES FOR HIGH PERFORMANCE SOLID STATE DEVICES,” issued on Sep. 18, 2012, all of which are hereby incorporated herein by reference in their entireties.

### TECHNICAL FIELD

The disclosed subject matter relates generally to providing a buffer between a memory controller and memory devices in high performance solid state devices.

### BACKGROUND

FIG. 1 depicts a block diagram of a multi-channel solid state device (SSD) 100. A typical multi-channel SSD 100 includes a SSD controller 102, external (or internal) buffers 104, a host interconnect 105, a plurality of channels 107, 109, 111, 113 and 115, and flash memory devices 108, 110, 112, 114, and 117, each of which is connected to each of channels 107, 109, 111, 113, and 115, respectively. SSD controller 102 includes a host interface 116, a processor 118, and a flash controller 120. Host interface logic 116 connects SSD controller 102 to an external host through host interconnect 105. Processor 118 controls the operation of each component of SSD controller 102. Flash controller 120 controls communication between SSD controller 102 and each of the flash memory devices 108, 110, 112, 114 and 116, over channels 107, 109, 111, 113, and 115. Each flash memory device includes one or more circuit dies that are contained within a package.

FIG. 2 depicts a SSD 200. SSD 200 has the same SSD controller 102 as multi-channel SSD 100 shown in FIG. 1. However, instead of having a plurality of channels, SSD 200 has one channel 210 that connects each of the flash memory devices 108, 110, 112, 114, and 116 to flash controller 120. Each channel may include one or more electrical traces, depending on the bit-width of the channel. The bit-width can indicate the number of bits that can be simultaneously communicated over the channel. Each flash memory device 108, 110, 112, 114, and 116 includes one or more circuit dies (shown as three dies in FIG. 2) that are contained within a package.

The number of channels in an SSD is determined by a capacity target and/or power consumption of the controller. An important design consideration for such controllers is the number of channels. Controllers often use many channels to satisfy the throughput requirement and to connect as many flash devices as needed to reach the target drive capacity. The embodiments of FIGS. 1 and 2 are amenable to prior flash interface speeds, which are around 40 MT/s to 166 MT/s (million transfers per second). MT/s is a measurement of channel speed in millions of effective cycles per second. It is a rate at which the data is actually transferred, as opposed to the frequency of the clock that drives the flash interface.

In the past few years, flash interface speed has increased from 40 MT/s to about 400 MT/s (+/−10%.) Furthermore, interface speeds are expected to exceed 400 MT/s in next few years. In addition to speed increases, the size increase of SSDs (i.e., the number of flash memory devices and dies increases) also causes the performance of the current SSD to deteriorate. For example, in a shared channel SSD, several flash devices share the same control and data channel to communicate with the controller. This means the load on the channel increases as the number of flash devices increase. The situation worsens as the number of dies within each flash device or the number of flash memory devices increases. This increase in the number of dies results in higher capacitive load per flash memory device. As an example, Table 1 shows the load for different packages that include two dies (dual die package (DDP)), four dies (quad die package (QDP)), and eight dies (octa die package (ODP)).

TABLE 1
Capacitive load of a flash device with multiple die in package

| Dual Channel DDP | Dual Channel QDP | Dual Channel ODP |
|---|---|---|
| 8 picofarads | 13 picofarads | 23 picofarads |

Driving large capacitive loads is an issue for both the SSD controller and flash devices. When designing a SSD controller, one could design or use an input/output (I/O) with a higher capacitance drive capability. However, such a design would impact the flash side limiting the device to 16 flash dies per channel, for example. As the number of flash memory devices increases, the capacitive load on the channel increases. This in turn causes the signal quality to decrease. For example, FIG. 3 depicts a Data Eye Diagram (DQ) at 200 MHz operation for a 32-die shared channel device with output state logic power voltage (VCCQ) of 3.3V. Specifically, FIG. 3 shows the signal quality when a flash memory device sends data to a controller in a 32-die shared channel environment. As shown, the data eye window is not recognizable. Therefore, the SSD controller cannot latch the incoming data from flash. Thus, at 200 MT/s, a 32-die shared channel device is unworkable using current techniques.

### SUMMARY

Some embodiments of the disclosed subject matter allow more flash devices to share the same channel within an SSD with high signal integrity, and yet provide support for future capacity extension. The present disclosure presents an SSD with a flash communication interface that can support flash memory devices operating at a speed of about or greater than 400 MT/s with high signal integrity. In some aspects, the SSD is designed to be operable at the speed of about 400 MT/s to 1 GT/s

Some embodiments of the disclosed subject matter include a solid state device system. The solid state device system can include a memory controller electrically coupled to a channel, wherein the memory controller is configured to select one of a plurality of flash memory devices and, in response to the selection, provide a control signal. The solid state device system can also include a buffer having a first tri-state logic gate coupled to the channel, wherein the buffer is configured to receive the control signal from the memory controller and, in response, to couple the channel to the selected one of the plurality of flash memory devices via the first tri-state logic gate and to decouple the remainder of the plurality of flash memory devices from the channel.

In one embodiment, the tri-state logic can include at least two inverters.

In any of the disclosed embodiments, the buffer can include a second tri-state logic gate coupled to the channel, wherein the first tri-state logic gate is configured to receive a signal from the channel and the second tri-state logic gate is configured to provide a signal to the channel, thereby providing bi-directional communication.

In any of the disclosed embodiments, the control signal is configured to enable only one of the first tri-state logic gate and the second tri-state logic gate at a time.

In any of the disclosed embodiments, the channel is configured to carry a clock signal from the memory controller to the selected one of the plurality of flash memory devices.

In any of the disclosed embodiments, the buffer is configured as a multiplexer.

In any of the disclosed embodiments, the multiplexer comprises a decoder that is configured to decode the control signal from the memory controller.

Some embodiments of the disclosed subject matter include a flash memory system. The flash memory system can include a plurality of flash memory devices electrically coupled to a channel, and a buffer electrically coupled to the channel and a port, which is configured to be coupled to a memory controller. The buffer can include a first tri-state logic gate coupled to the port, wherein the buffer is configured to receive a select signal from the memory controller and, in response, to couple one of the plurality of flash memory devices to the port via the first tri-state logic gate and to decouple the remainder of the plurality of flash memory devices from the port.

In one embodiment, the buffer can include at least two inverters.

In any of the disclosed embodiments, the buffer can include a second tri-state logic gate coupled to the port, wherein the first tri-state logic gate is configured to receive a signal from the port and the second tri-state logic gate is configured to provide a signal to the port, thereby providing bi-directional communication.

In any of the disclosed embodiments, the select signal is configured to enable only one of the first tri-state logic gate and the second tri-state logic gate at a time.

In any of the disclosed embodiments, the port is configured to carry a clock signal from the memory controller to the selected one of the plurality of flash memory devices.

In any of the disclosed embodiments, the buffer is configured as a multiplexer.

In any of the disclosed embodiments, the multiplexer comprises a decoder that is configured to decode the control signal from the memory controller.

Some embodiments of the disclosed subject matter include a solid state device. The solid state device can include an application specific integrated circuit (ASIC) controller having a port, a plurality of flash memory devices, wherein each flash memory device is configured to be in electrical communication with the port associated with the ASIC controller, and a buffer having a first tri-state logic gate electrically coupled to the port. The buffer can include a first tri-state logic gate coupled to the port, wherein the buffer is configured to receive a select signal from the memory controller and, in response, to couple one of the plurality of flash memory devices to the port via the first tri-state logic gate and to decouple the remainder of the plurality of flash memory devices from the port.

In one embodiment, the buffer can include at least two inverters.

In any of the disclosed embodiments, the buffer can include a second tri-state logic gate coupled to the port, wherein the first tri-state logic gate is configured to receive a signal from the port and the second tri-state logic gate is configured to provide a signal to the port, thereby providing bi-directional communication.

In any of the disclosed embodiments, the select signal is configured to enable only one of the first tri-state logic gate and the second tri-state logic gate at a time.

In any of the disclosed embodiments, the buffer is configured as a multiplexer.

In any of the disclosed embodiments, the multiplexer comprises a decoder that is configured to decode the control signal from the memory controller.

### DESCRIPTION OF FIGURES

FIG. 1 depicts a block diagram of a Multi-Channel SSD .

FIG. 2 depicts a single channel SSD .

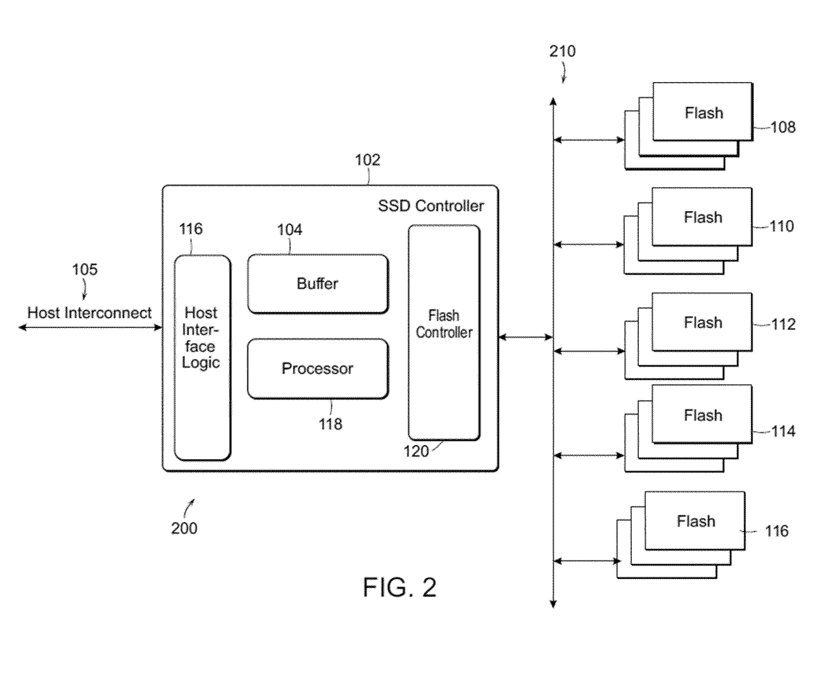

FIG. 3 depicts a Data Eye Diagram (DQ) of a signal on an SSD operating at 200 MHz operation; VCCQ of 3.3V.

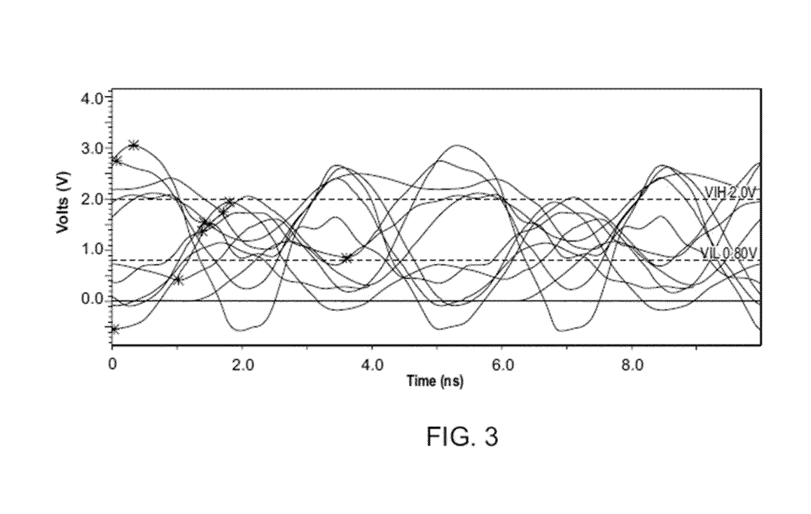

FIG. 4 depicts a block diagram of a single-channel SSD using isolation devices in a physical channel according to some embodiments of the disclosed subject matter.

FIG. 5 depicts a block diagram of a single-channel SSD using isolation devices in a physical channel, where the use of switches doubles the capacity without affecting the performance according to embodiments of the disclosed subject matter.

FIG. 6 illustrates a memory system having a multiplexer according to embodiments of the disclosed subject matter.

FIG. 7 illustrates a multiplexer having a 1:N buffer switch in accordance with some embodiments of the disclosed subject matter.

FIG. 8 illustrates a multiplexer having a clock buffer switch in accordance with some embodiments of the disclosed subject matter.

FIG. 9 illustrates a multiplexer having a signal amplifier in accordance with some embodiments of the disclosed subject matter.

FIG. 10 depicts a diagram of an SSD I/O port with an electrostatic discharge (ESD) protection circuit.

### DESCRIPTION

The disclosed subject matter relates to a single or multiple shared channel SSD with isolation devices. An isolation device can isolate flash memory devices and/or memory dies from each other such that the flash controller only sees one flash memory device at a time. An isolation device can be configured so that a flash memory device does not see other flash memory devices that share the same channel. This isolation technique can reduce capacitive load to the flash memory device controller and/or the flash memory devices, thereby improving the performance of SSDs in terms of speed and drive capacity.

The isolation technique is particularly useful when it is used with application specific integrated circuit (ASIC) controllers. The design for ASIC controllers is often fully customized. It therefore has smaller form factor as compared to other type of controllers. In other words, an ASIC controller often has limited number of I/O ports because extra or excess I/O ports can consume additional die area and increase the size of packages as well as the printed circuit board. In addition, extra ports consume additional power regardless of its operational state. For these and other reasons, traditional ASIC controllers are designed according to tailored specifications and thus, have limited room to accommodate additional flash memory devices later on. These limitations associated with ASIC controllers can be mitigated using the disclosed isolation technique. For example, an already-designed ASIC controller with a limited number of I/O ports can interface with multiple flash memory devices using load isolation. The disclosed isolation technique does not depend on how the ASIC controller is designed. In addition, the disclosed isolation technique allows an ASIC controller to interface with more flash memory devices than in previous designs. As will be discussed, a number of flash memory devices can be coupled to a single channel (for example I/O port) using one or more isolation devices. Therefore, high performance SSDs can be manufactured using load isolation. The isolation device can be a switch, for example a FET. The disclosed SSD permits an increase in capacity without affecting performance and power consumption. This is different from existing designs, where each flash memory device has a dedicated channel and a corresponding dedicated I/O port on the controller.

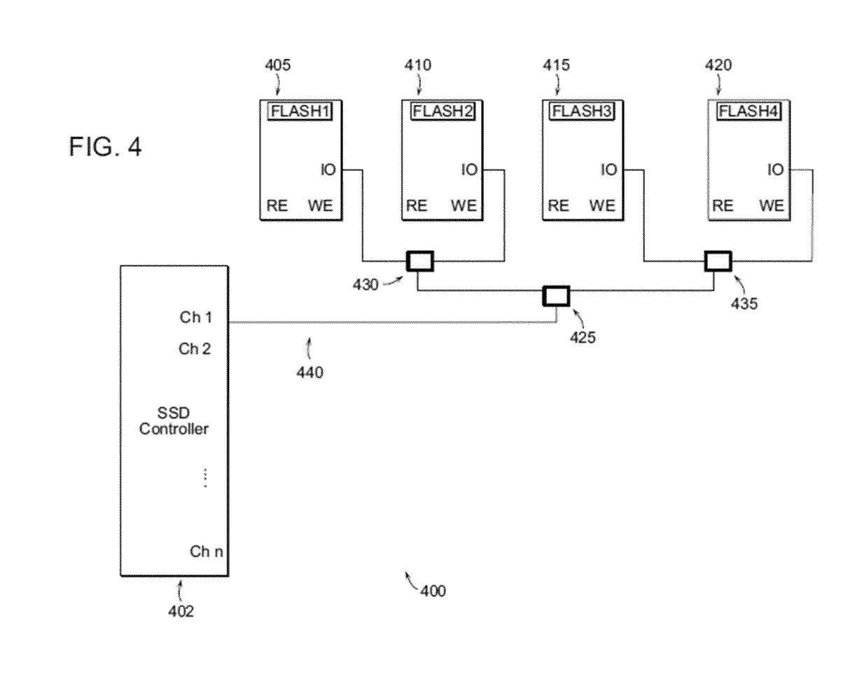

These isolation devices can be used in SSDs using a shared channel. FIG. 4 illustrates a block diagram of a multi-channel SSD using isolation devices in a physical channel, according to various embodiments of the disclosed subject matter. Because each flash memory device communicates with the controller 402 over a single channel 440 at a rate of about 400 MT/s or higher, a simultaneous operation of all flash memory devices is impracticable. While simultaneous transmission is possible, it is not desirable because of, for example, high power consumption and large channel requirements. FIG. 4 illustrates how isolation devices can be employed in a SSD to reduce the load seen by the SSD controller and each flash memory device. Specifically, SSD 400 can include a controller 402 that is electrically coupled to a first flash memory device 405, a second flash memory device 410, a third flash memory device 415, and a fourth flash memory device 420 through a single channel 440. These flash memory devices can be designed to operate at a fast speed. Furthermore, the flash memory devices can be fabricated using advanced fabrication processes with small footprints, for example, 32nm process, a 22nm process, or lower.

SSD device 400 also includes three isolation devices, a first isolation device 425, a second isolation device 430, and a third isolation device 435. By using these isolation devices, the flash controller or the selected flash memory device can see the load of only one device (either the selected memory or the flash controller) that is selected and connected to the other end of the channel 440. For example, if controller 402 selects first flash memory device 405 by triggering the first isolation device 425 and second isolation device 430, controller 402 will only see first flash memory device 405 and will not see the loads produced by any other flash memory devices (i.e., second flash memory device 410, third flash memory device 415 and fourth flash memory device 420.) Similarly, first flash memory device 405 will only see controller 402 and not the loads produced by second flash memory device 410, third flash memory device 415 and fourth flash memory device 420. Thus, the loads produced by second flash memory device 410, third flash memory device 415 and fourth flash memory device 420 are completely disconnected from the shared channel and the load of that device will be hidden to either of the other two active ends. The arrangement of the isolation devices in SSD 400 provides low propagation delay and low data I/O capacitance. Low data I/O capacitance is desirable because it can reduce capacitive loading and signal distortion associated with the data channel. Isolation devices 425, 430, and 435 are coupled to one another via a channel. The channel can be an electrical channel.

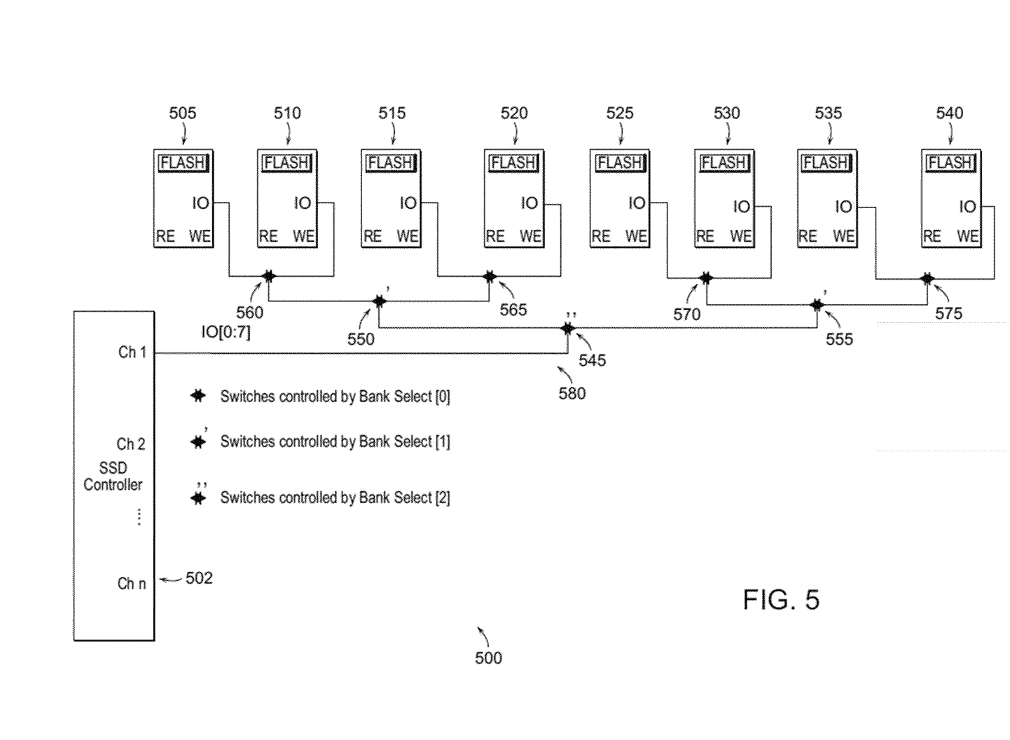

Controller 402 includes logic for selecting any one of the flash memory devices or dies through activation or selection of the corresponding isolation device or devices. Adding one or more additional isolation devices can allow for a deeper level of load isolation. Deeper load isolation can give scalability for capacity extension. FIG. 5 depicts a block diagram of an SSD 500 using isolation devices in a single physical channel, where the use of tiered load isolation devices doubles the capacity without affecting the performance, according to embodiments of the disclosed subject matter. FIG. 5 shows how the number of flash devices that share the same channel can be doubled without compromising the performance. SSD 500 includes a controller 502 connected to eight flash memory devices through a single channel 580: a first flash memory device 505, a second flash memory device 510, a third flash memory device 515, a fourth flash memory device 520, a fifth flash memory device 525, a sixth flash memory device 530, a seventh flash memory device 535, and an eighth flash memory device 540. Controller 502 connects to the eight flash memory devices 505-540 through seven isolation devices: a first isolation device 545, a second isolation device 550, a third isolation device 555, a fourth isolation device 560, a fifth isolation device 565, a sixth isolation device 570, and a seventh isolation device 575. Therefore, when controller 502 requests or sends information to fifth flash memory device 525, controller 502 selects first, third and sixth isolation devices (545, 555, and 570) and only sees fifth flash memory device 525 and not the other seven flash memory devices connected on the single channel.

In one embodiment, the isolation device can be a switch or an array of switches. For example, the switch or array of switches can be FET. The FET can include an N-channel FET with low resistance when turned on and high impedance when turned off While FET switches are used in some embodiments, any other type of switches that has a low propagation delay and does not degrade signal quality can also be used. In some embodiments, the FET switches can be configured as a de-multiplexer to connect one input to one of a plurality of outputs and vice versa as a multiplexer.

In one embodiment, the isolation device can include a buffer. The buffer can be configured to couple a high-impedance voltage source to a low-impedance load without significant attenuation or distortion of the signal from the high-impedance voltage source. In some cases, the buffer can include two inverters in a chain.

In some cases, the buffer can include a tri-state logic gate. A tri-state logic gate can assume three output states: a low logic state; a high logic state; and a high impedance state. When the tri-state logic gate is enabled, then the tri-state logic gate can operate as a regular buffer: providing the received signal at the output. When the tri-state logic gate is disabled, the tri-state logic gate can enter a high impedance state, in which case the tri-state logic gate does not drive (or provide any output to) the output node. In other cases, the buffer can also include a voltage amplifier. In some cases, the buffer can accommodate bi-directional communication. For example, the buffer can include two tri-state logic gates. The bi-directional buffer can be formed by configuring one of the tri-state logic gates to provide signal transmission from the flash controller 102 to flash memory devices and configuring the other tri-state logic gate to provide signal transmission from flash memory devices to the flash controller 102. By turning on one of the tri-state logic gates at a time, the two tri-state logic gates can operate as a bi-directional buffer.

In some cases, the buffer can be a part of a multiplexer. For example, the isolation device can be a part of a multiplexer that is configured to multiplex a channel, coupled to a memory controller, to one of a plurality of channels, each coupled to a flash memory device. In some cases, the memory controller can determine (or select) which flash memory device can be coupled to the memory controller via the multiplexer; in other cases, other types of controller can determine (or select) which flash memory device can be coupled to the memory controller via the multiplexer. The memory controller or other controllers can send a control signal to the multiplexer so that the multiplexer can couple the flash memory device to memory controller. In some embodiments, the multiplexer can include a decoder that can decode the control signal to determine which one of the flash memory devices should be coupled to the memory controller.

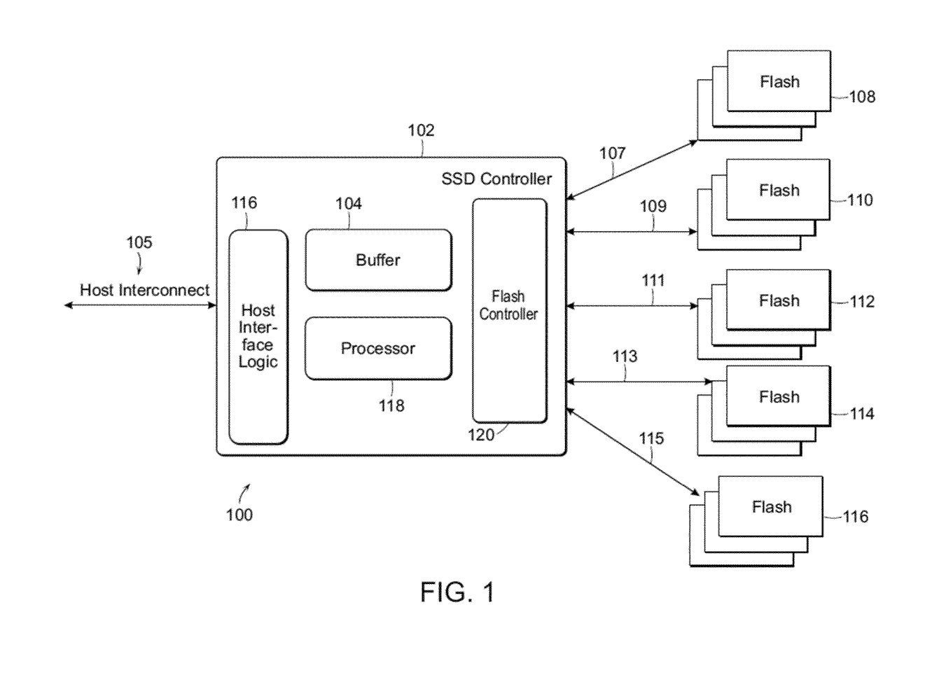

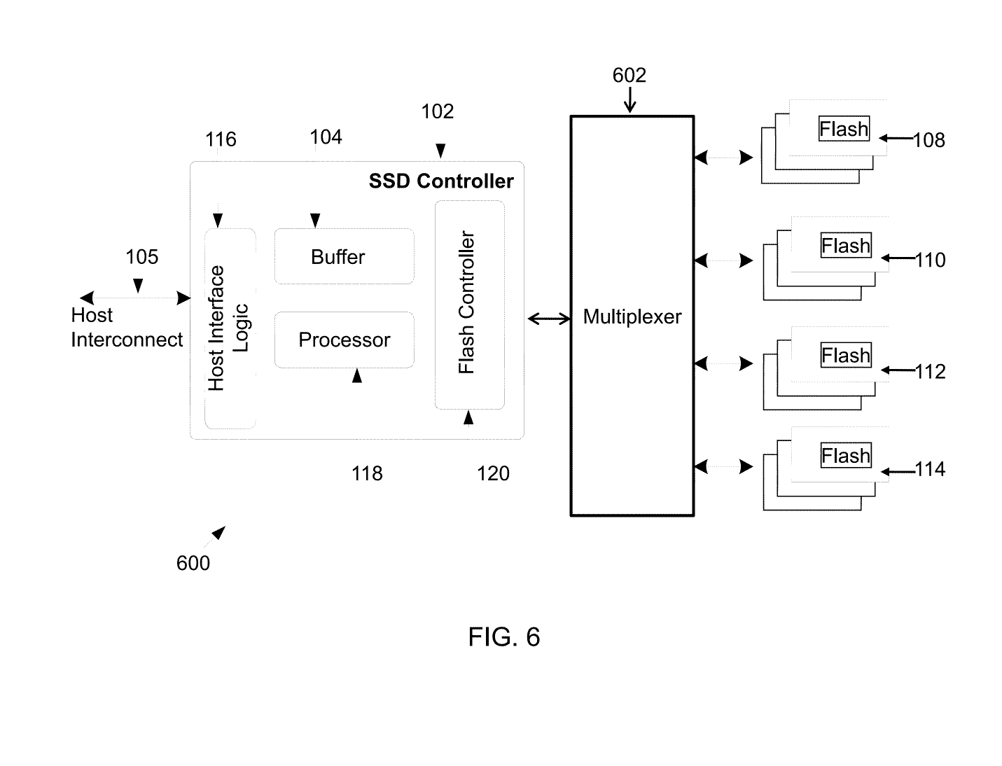

FIG. 6 illustrates a memory system having a multiplexer in accordance with some embodiments of the disclosed subject matter. FIG. 6 includes a SSD 600. The SSD 600 can include the same SSD controller 102 as the multi-channel SSD 100 illustrated in FIG. 1. The SSD 600 has one channel 210, with a multiplexer 602 that connects each of the flash memory devices 108, 110, 112, and 114 to SSD controller 102. Each flash memory device 108, 110, 112, and 114 includes one or more circuit dies (shown as three dies in FIG. 6) that are contained within a single package. The multiplexer 602 can include a switch or a buffer that couples only one of the flash memory device 108, 110, 112, and 114 to the SSD controller 102 based on a memory selection signal provided to the multiplexer 602.

Using a buffer in the multiplexer 602 can be beneficial for improving the rise time and the linearity of a signal between the SSD controller 102 and the flash memory devices. For example, if the SSD controller 102 does not have a strong, large buffer to drive the capacitive loading between the SSD controller 102 and the flash memory devices, the signal transmitted by the SSD controller 102 can be delayed, and may also be distorted (i.e., the SSD controller 102 can send a logic 1 to a flash memory device, but the flash memory device perceives it as a logic 0.) The buffer in the multiplexer 602 can address this issue. The buffer in the multiplexer 602 can (1) decouple the SSD controller 102 and the flash memory devices and (2) drive the large capacitive loading seen by the SSD controller 102 to reduce the signal delay and the signal non-linearity. Likewise, the buffer in the multiplexer 602 can provide similar benefits to signals transmitted by the flash memory devices.

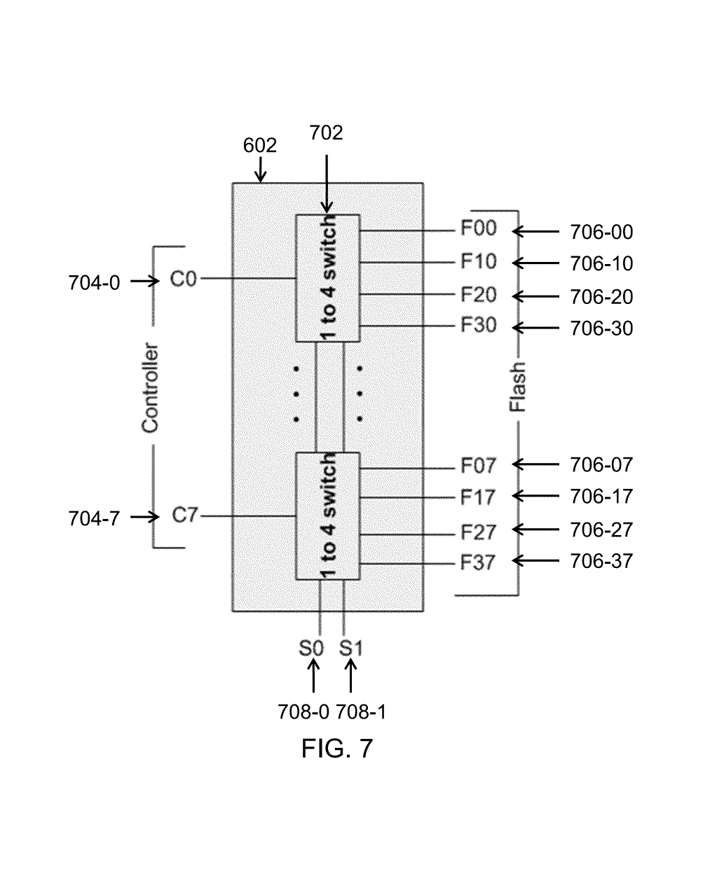

FIGS. 7-9 illustrate various embodiments of the multiplexer 602. FIG. 7 illustrates a multiplexer having one or more 1:N buffer switches in accordance with some embodiments of the disclosed subject matter. The multiplexer 602 is configured to couple a single channel from the flash controller 102 to one of N flash memory devices. The multiplexer 602 can include one or more 1:N buffer switches 702 to couple one or more channels from the flash controller 102 to N flash memory devices. In this illustration, N is 4.

In some embodiments, the 1:N buffer switch 702 can be uni-directional, accommodating data flow in a single direction, either (1) from the flash controller 102 to one of the flash memory devices, or (2) from one of the flash memory devices to the flash controller 102. In other embodiments, the 1:N buffer switch 702 can be bi-directional, accommodating data flow in both directions.

In some embodiments, the multiplexer 602 can accommodate parallel data transfer of a predetermined number of bits, based on the bit-width of the channel. For example, as illustrated in FIG. 7, the multiplexer 602 can accommodate a parallel transfer of 8-bits of data. Cn 704-0, . . . , 704-7 each indicates a bit of data received from/sent to the flash controller 102 (or an electrical trace within the channel coupled to the flash controller 102), where “n” indicates the bit-position within the data (or the bit-position of the electrical trace within the channel); Fmn 706-00 . . . 706-37 indicates a bit of data received from/sent to one of the flash memory devices, where “n” indicates the bit-position within the data (or the bit-position of the electrical trace within the channel) and “m” indicates the flash memory to which the bit is directed. In this example, the bit-width of the channel is eight. Thus, the multiplexer 602 can simultaneously route the 8-bits of data 704 from the flash controller 102 to 8 of 32 channels 706 coupled to flash memory devices. The multiplexer 602 can be controlled using selection signals 708-0, 708-1. Based on the configuration of the selection signals 708, the multiplexer 602 can select one of the flash memory devices, and provide communication between the memory controller 102 and the selected one of the flash memory devices. In some cases, the selection signals can be provided by the flash controller 102.

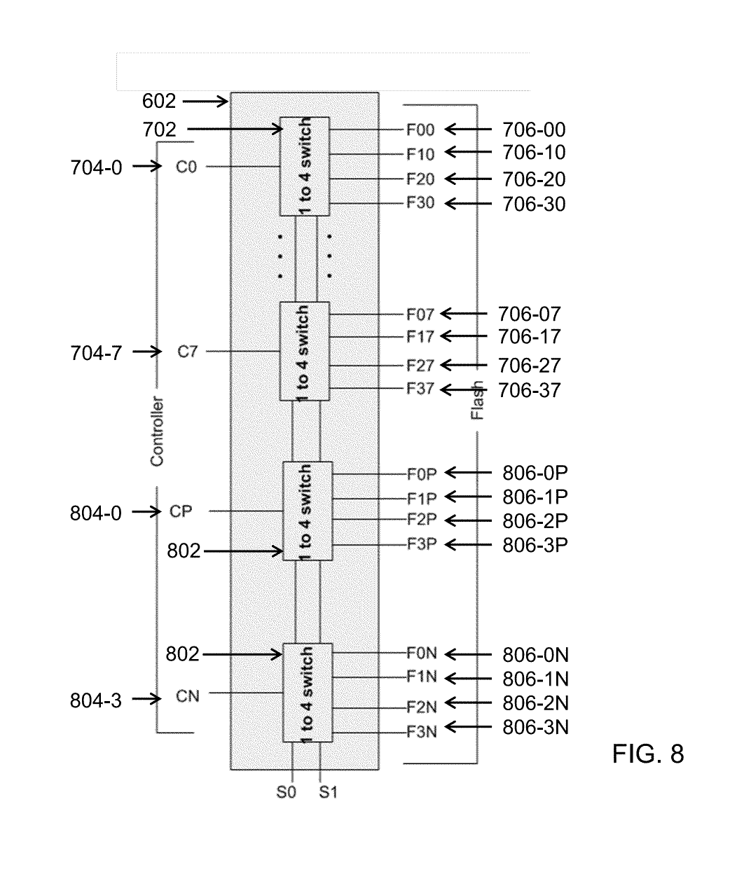

FIG. 8 illustrates a multiplexer 602 that is also configured to distribute clock signals in accordance with some embodiments of the disclosed subject matter. A portion of the multiplexer illustrated in FIG. 8 is substantially similar to the multiplexer illustrated in FIG. 7. For example, the 1:N buffer switch 702 can route data from the SSD controller 102 to one of the flash memory devices. The multiplexer illustrated in FIG. 8 further includes one or more switches 802 configured to route a clock signal from the flash controller 102 to the flash memory devices 108, 110, 112, and 114. The clock signal can include a signal from a single-ended clock generator; the clock signal can include two or more signals from an out-of-phase clock generator, such as a differential clock generator, a tri-phase clock generator, or an N-phase clock generator. The illustrated multiplexer 802 is configured to route differential clock signals CP 804-0, CN 804-3 to one of the channels 806-0P . . . 806-3P, and 806-0N . . . 806-3N, respectively. This way, the multiplexer 602 can route the differential clock signals to one of the four flash memory devices coupled to the buffer switches 802. In some embodiments, the multiplexer 602 can route the differential clock signals and the data simultaneously.

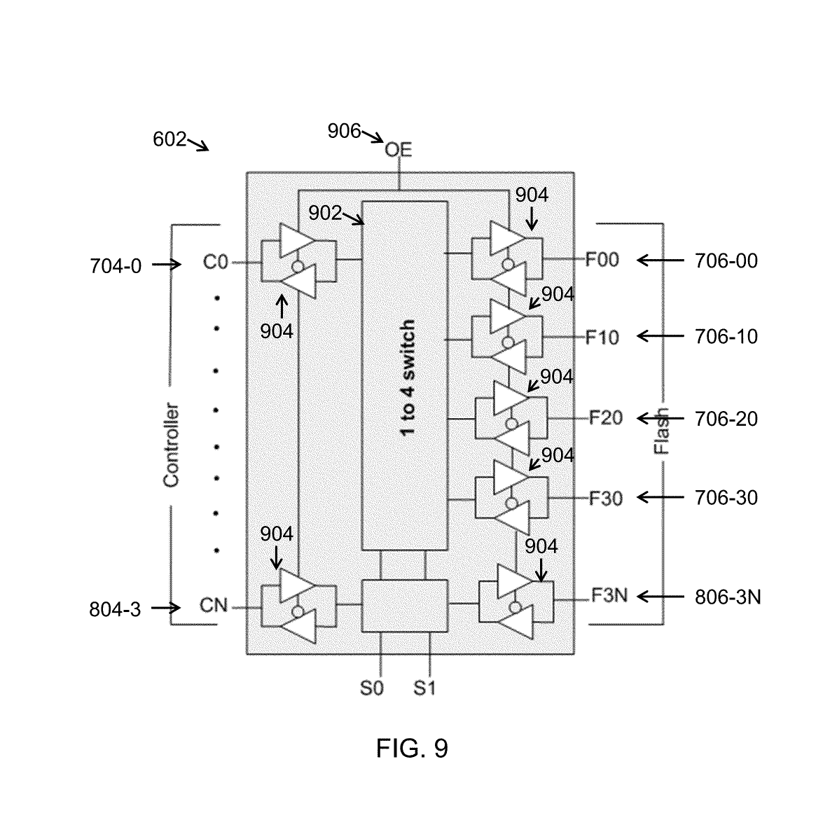

FIG. 9 illustrates a multiplexer having a plurality of signal amplifiers in accordance with some embodiments of the disclosed subject matter. Signal amplifiers can be useful for multiplexers when signal amplitudes are too small to detect. Signal amplifiers 904 can increase the amplitude of the signals so that the flash controller 102 and the flash memory devices can communicate without significant communication error. In some embodiments, one or more signal amplifiers 904 can be placed between the 1:N switch 902 and the flash controller 102 (not shown). In some embodiments, signal amplifiers 904 can also be placed between the 1:N switch 902 and the flash memory devices.

Signal amplifiers 904 can be configured to accommodate bi-directional communication. For example, signal amplifiers 904 can include two tri-state amplifiers where each amplifier is configured to provide signal communication in one direction. By enabling only one of the tri-state amplifiers at a time, signal amplifiers 904 can operate as a bi-directional amplifier. These tri-state amplifiers can be enabled using an Output Enable (OE) signal 906. For example, when the OE signal 906 is low, the multiplexer 602 can provide signal communication from the flash memory devices to the flash controller 102; when the OE signal 906 is high, the multiplexer 602 can provide signal communication from the flash controller 102 to the flash memory devices. In some embodiments, signal amplifiers 904 can be configured to provide a gain of 1, in which case signal amplifiers 904 can operate simply as bi-directional buffers.

In some embodiments, the multiplexer 602 can be decoupled from the power supply. The multiplexer 602 can be decoupled from the power supply upon a detection of a predetermined condition. The predetermined condition can include a power irregularity of the SSD system. For example, the SSD controller 102 can receive an indication from a power regulator that the power supply has been disrupted, and provide that information to the multiplexer as a multiplexer 602 disable signal. Upon receiving the multiplexer disable signal, the multiplexer 602 can be electrically disconnected from SSD controller 102 thereby isolating the flash memory devices. This way, the flash memory devices can be shielded from any power irregularities (e.g., power surge) coming from SSD controller 102. This capability of disengaging flash memory devices from such signal irregularities is even more crucial in flash memory devices with power backed up by a reserve power source, such as tantalum capacitors, for example. In these types of flash memory devices, it is expected that any page write operation that is already in place will continue before the power completely fails. As a result, without the protection of the isolation device 200 or the multiplexer 602, a power glitch may propagate through and change the flash control signals to an active state and disturb the last write.

In certain existing or commercially available designs, electrostatic discharge (ESD) protected ports can be used to protect flash memory devices that are connected to SSD controllers. ESD can arise from a number of reasons and come from various sources. For example, ESD problems can occur when the controllers are used in abnormal operating conditions, being handled inappropriately, or the controllers are designed on poor printed circuit boards. While ESD protected ports are frequently used to overcome ESD problems, the overall design and size of a SSD can increase because of the presence of the ESD protection circuits that are associated with ESD protected ports. In addition, ESD protection circuits draw power and cause a greater overall power demand by the SSD . The use of ESD protected ports therefore may impede the trend of attaining smaller size and densely packed circuit boards.

The trend in the industry is to create smaller and higher density printed circuit boards, smaller I/O ports, line width, and channels. Thus, ESD protection circuits for I/O ports may not be provided in some instances. In addition, the changes in the I/O ports design alone increase the susceptibility of the printed circuits to ESD damage because the tolerable current of the printed circuit board components can be reduced. To overcome these issues, the isolation device 200 or the multiplexer 602 may be used to protect flash memory devices from ESD damage in lieu of using ESD protected ports.

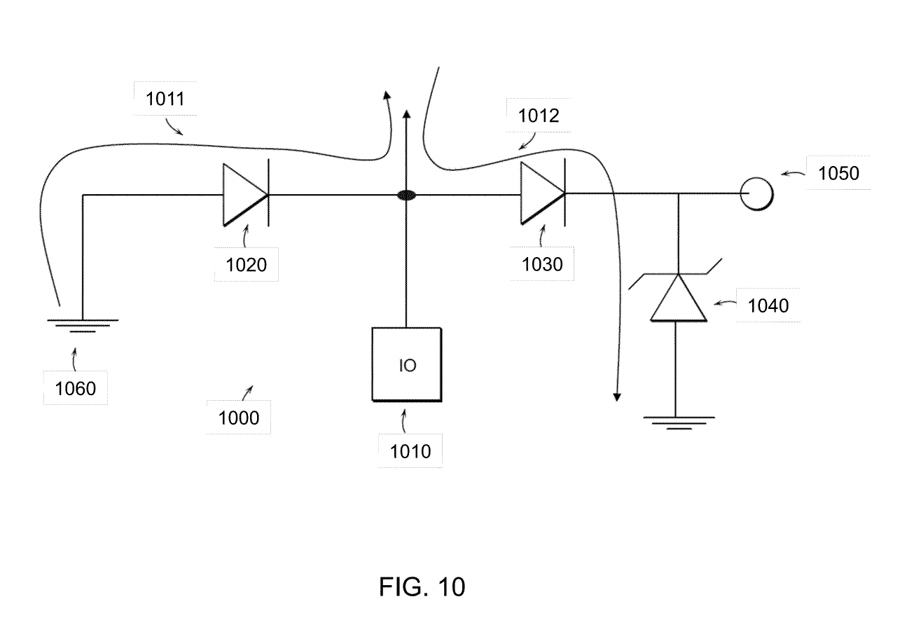

In some embodiments, the isolation device 200 or the multiplexer 602 can include an ESD protected port to further protect flash memory devices from power glitches that are caused by power cut-off. FIG. 10 illustrates a diagram of a typical ESD protected port 1000. Clamping or ESD diodes 1020 and 1030 are provided on each supply rail going to and from the I/O port 1010 (e.g., from I/O port 1010 to ground 1060 and from I/O port 1010 to power supply 1050.) ESD protected circuit prevents damage to I/O port 1010 by routing ESD pulses away and thereby removing supply voltage from the port. Positive ESD pulses 1012 are clamped to the positive supply rail and routed to a zener diode 1040, and negative ESD pulses 1011 are clamped to ground. However, at the moment that the I/O port supply voltage is cut off in the event of negative ESD event, for example, the diode will forward bias and then drag the I/O port 1010 down to near ground.

In some embodiments, the isolation devices are arranged in a tree topology in which each isolation device is electrically coupled to one another via electrical channels. In other words, the isolation devices are arranged as nodes in the tree topology, and the electrical channels are arranged as edges in the tree topology. The tree topology can include channel branches that electrically couple two or more isolation devices. The tree topology can include a binary tree topology, as illustrated in FIGS. 4 and 5. The tree topology can also include a skewed tree topology. The tree topology can be selected based on the number of flash memory devices, the differences in flash memory device capacities, and/or flash memory device access pattern.

In some embodiments, the isolation devices can be used in combination with multiple channels to increase the performance and capacity of the SSD. For example, to obtain a 16 flash memory device SSD, two channels from the SSD controller can each be connected to eight flash memory devices as shown in FIG. 5. Additionally, the isolation devices can be used within each flash memory device to isolate each particular die. Therefore, a high performing 16, 32, 64, 128, die single channel SSD can be created.

Other than load isolation, there are additional advantages to using isolation devices for SSDs. These advantages include a reduction of power consumption of the entire system because a smaller load seen by the controller and flash devices. Smaller loads can be translated to a reduction in drive strength on both sides of the I/O.

In conventional SSD controllers, the loading issue can be addressed by adding channels or increasing the number of control pins on each physical channel. Isolation devices eliminate the need for adding extra channels and extra control pins, resulting in a smaller die size and less power consumption.

Those of skill in the art would appreciate that the various illustrations in the specification and drawings described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (for example, arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

The terms “SSD”, “SSD device”, and “SSD device” as used herein are meant to apply to various configurations of solid state device devices equipped with SSD controllers and isolation devices in accordance with one or more of the various embodiments of the disclosed subject matter. It will be understood that other types of non-volatile mass storage devices in addition to flash memory devices may also be utilized for mass storage.

We claim:

1. A solid state device system comprising:
a memory controller electrically coupled to a channel, wherein the memory controller is configured to select one of a plurality of flash memory devices and, in response to the selection, provide a control signal; and
a buffer comprising a first tri-state logic gate coupled to the channel, wherein the buffer is configured to receive the control signal from the memory controller and, in response, to couple the channel to the selected one of the plurality of flash memory devices via the first tri-state logic gate and to decouple the remainder of the plurality of flash memory devices from the channel.

2. The solid state device system of claim 1, wherein the tri-state logic comprises at least two inverters.

3. The solid state device system of claim 1, wherein the buffer comprises a second tri-state logic gate coupled to the channel, wherein the first tri-state logic gate is configured to receive a signal from the channel and the second tri-state logic gate is configured to provide a signal to the channel, thereby providing bi-directional communication.

4. The solid state device system of claim 3, wherein the control signal is configured to enable only one of the first tri-state logic gate and the second tri-state logic gate at a time.

5. The solid state device system of claim 1, wherein the channel is configured to carry a clock signal from the memory controller to the selected one of the plurality of flash memory devices.

6. The solid state device system of claim 1, wherein the buffer is configured as a multiplexer.

7. The solid state device system of claim 6, wherein the multiplexer comprises a decoder that is configured to decode the control signal from the memory controller.

8. A flash memory system comprising:
a plurality of flash memory devices electrically coupled to a channel;
a buffer electrically coupled to the channel and a port, which is configured to be coupled to a memory controller, wherein the buffer comprises a first tri-state logic gate coupled to the port, wherein the buffer is configured to receive a select signal from the memory controller and, in response, to couple one of the plurality of flash memory devices to the port via the first tri-state logic gate and to decouple the remainder of the plurality of flash memory devices from the port.

9. The flash memory system of claim 8, wherein the buffer comprises at least two inverters.

10. The flash memory system of claim 8, wherein the buffer comprises a second tri-state logic gate coupled to the port, wherein the first tri-state logic gate is configured to receive a signal from the port and the second tri-state logic gate is configured to provide a signal to the port, thereby providing bi-directional communication.

11. The flash memory system of claim 10, wherein the select signal is configured to enable only one of the first tri-state logic gate and the second tri-state logic gate at a time.

12. The flash memory system of claim 8, wherein the port is configured to carry a clock signal from the memory controller to the selected one of the plurality of flash memory devices.

13. The flash memory system of claim 8, wherein the buffer is configured as a multiplexer.

14. The flash memory system of claim 8, wherein the multiplexer comprises a decoder that is configured to decode the control signal from the memory controller.

15. A solid state device comprising:
an application specific integrated circuit (ASIC) controller having a port;
a plurality of flash memory devices, wherein each flash memory device is configured to be in electrical communication with the port associated with the ASIC controller; and
a buffer comprising a first tri-state logic gate electrically coupled to the port, wherein the buffer comprises a first tri-state logic gate coupled to the port, wherein the buffer is configured to receive a select signal from the memory controller and, in response, to couple one of the plurality of flash memory devices to the port via the first tri-state logic gate and to decouple the remainder of the plurality of flash memory devices from the port.

16. The solid state device of claim 15, wherein the buffer comprises at least two inverters.

17. The solid state device of claim 15, wherein the buffer comprises a second tri-state logic gate coupled to the port, wherein the first tri-state logic gate is configured to receive a signal from the port and the second tri-state logic gate is configured to provide a signal to the port, thereby providing bi-directional communication.

18. The solid state device of claim 17, wherein the select signal is configured to enable only one of the first tri-state logic gate and the second tri-state logic gate at a time.

19. The solid state device of claim 15, wherein the buffer is configured as a multiplexer.

20. The solid state device of claim 15, wherein the multiplexer comprises a decoder that is configured to decode the control signal from the memory controller.
